(19) United States
(12) Patent Application Publication
(10) Pub. No.: US 2018/0224384 A1
(43) Pub. Date: Aug. 9, 2018

(54) ELECTRODE SYSTEM

(71) Applicant: HEWLETT-PACKARD DEVELOPMENT COMPANY, L.P., Houston, TX (US)

(72) Inventors: Tod WOODFORD, Corvallis, OR (US); Hilary ELY, Corvallis, OR (US); Sadiq BENGALI, Corvallis, OR (US)

(21) Appl. No.: 15/749,319

(22) PCT Filed: Jan. 29, 2016
(86) PCT No.: PCT/US2016/015568

§ 371 Date: Jan. 31, 2018

(51) Int. Cl. G01N 27/02

(52) U.S. Cl. CPC G01N 27/02

(57) ABSTRACT

An electrode system and a method of using an electrode system to make an impedance measurement. The electrode system comprises a substrate that supports a first and second electrodes. The first electrode is located inside a cutout of the second electrode. The first and second electrodes are separated by an insulating layer.

### BACKGROUND

Test methods measure some property of a sample. That property may be used to make inferences about the sample. For example, measuring the conductivity of salt water may allow inference of the ion concentration in the salt water. However, in measurement of sample properties, the measurement is also a function of the piece of equipment and the environment. Accordingly, when assessing measurements, it is relevant to consider the impact of equipment and the environment. It also follows that, depending on the environment, some equipment designs may be more or less effective at producing accurate measurements of sample properties. Accordingly, it is desirable for measurement systems to minimize environmental noise and produce accurate, repeatable measurements.

### BRIEF DESCRIPTION OF THE DRAWINGS

The accompanying drawings illustrate various examples of the principles described herein and are a part of the specification. The illustrated examples are intended to describe possible implementations and do not limit the scope of the claims. Like numerals denote similar but not necessarily identical elements.

FIGS. 1A and 1B show an example of an electrode system consistent with this specification. FIG. 1A shows an overhead view and FIG. 1B shows a cross-sectional view.

FIG. 2 shows an overhead view of an example electrode system consistent with this specification.

FIG. 3 shows a cross-sectional view of an example electrode system consistent with this specification.

FIG. 4 shows a cross-sectional view of an example electrode system consistent with this specification.

FIG. 5 shows an overhead view of an example electrode system consistent with this specification.

FIG. 6 shows a cross-sectional view of an example electrode system consistent with this specification.

FIG. 7 shows an example method consistent with this specification.

### DETAILED DESCRIPTION

One property relevant to the characterization of a fluid is the impedance of the fluid. Impedance is the relationship between voltage and current through the fluid. Impedance may be defined as the effective resistance to alternating current.

Measuring impedance of a solution may be performed by measuring the voltage and current between two electrodes in contact with the solution. However, current may be distributed non-uniformly across the surface of the electrodes. It can be conceptually helpful to think of the current as distributing through a number of parallel paths traveling between the two electrodes. The current distributes so that the voltage drop is equal for all the paths. Thus, if one path is less resistive and causes a smaller voltage drop, the amount of current traveling through that path increases until the voltage drop is the same. Similarly, if a given path has a higher voltage drop, then the amount of current traveling that path drops until the voltage drop is equal. One contributor to the variation in the paths is the geometries and relative positions of the electrodes.

With a pair of flat, infinite electrodes separated by a fixed distance, the field between the two electrodes is the same everywhere, and any measurement is similarly uniform. However, creating large electrodes may be challenging in many designs due to cost and space constraints. The introduction of real world geometries can produce non-uniformity. For example, consider two square electrodes separated by a fixed distance. Assuming the separation is small compared with the size of the electrodes, the centers of the electrodes act very much like the pair of infinite electrodes. However, the edges and corners act differently. The edge has a lower resistance to current flow because the current can flow not just straight between the plates but also out beyond the edge of the plate. This lower resistance, in turn, produces greater current flow through the edge of the plate than through an equivalent area in the center of the plate. This non-uniform distribution of current is used in electro-polishing and other electrochemical techniques. Broadly speaking, the larger the amount of fluid through which the current from a given area of an electrode can flow, the more current will flow through that portion of the electrode. Thus, peaks, edges, dendrites, points, etc. all show increased current flow per unit of surface area while valleys, holes, hollows, etc. show decreased current flow per unit of surface area.

Returning to the two plate electrodes, if the edge is a small fraction of the surface area of the plate, then its contribution to the measurement may be small compared to the overall relatively uniform behavior of the two plates. However, as the area of the non-uniform areas increases, the impact on the measurement increases and may eventually come to dominate the measurement. This may present a challenge for small electrode systems. In such systems, the edge effects play a significant role in the measurements. This is because, as the electrodes become smaller, the ratio of edge to area of the electrode increases, similar to the way that small particles have very high surface area to mass ratios. Accordingly, as electrode areas become small, the impact of edge effects become larger. Thus, for microelectrodes, achieving uniformity of the field between the two electrodes allows robust measurement.

Another challenge with microelectrodes is that they tend to be placed in close proximity to each other and to other parts of a micro-electromechanical system (MEMS). Close proximity can result in crosstalk and interference to the microelectrode which may increase the noise and/or reduce signal and result in a decreased signal to noise ratio (S/N ratio). Accordingly, there is a need for microelectrode designs that facilitate accurate, repeatable measurement of solution properties.

Accordingly, the present specification describes, among other examples, an electrode system, An electrode system, the system comprising: a substrate defining a plane; a first, inner electrode, on the substrate; a second, outer electrode with a cutout, on the substrate, wherein the first electrode is inside the cutout of the second electrode; and an insulating layer separating the first electrode and the second electrode.

The present specification also describes a method of making an impedance measurement, where the method comprises: measuring an impedance of a solution between a first electrode and a second electrode, wherein the first electrode has a circular perimeter, the second electrode has a round interior cutout, and the first electrode is centered in the cutout of the second electrode.

The present specification also describes a system for making electrical measurements, the system comprising: a first electrode and second electrode on a surface. The first electrode has a smooth outer perimeter. The second electrode completely surrounds the first electrode on the surface. The minimum separation between the first electrode and the second electrode on the surface is uniform at all points of a circumference of the first electrode.

Turning now to the figures:

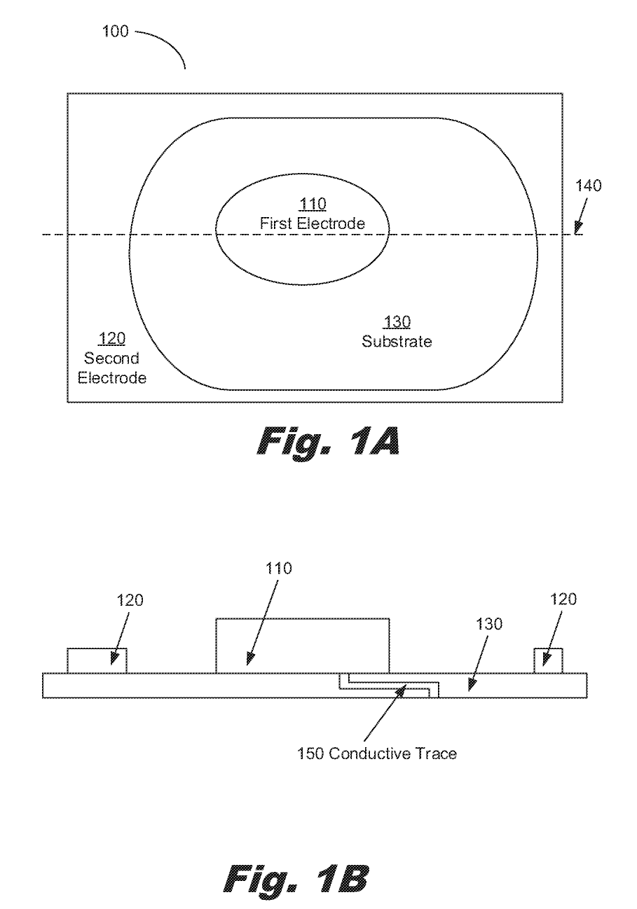

FIG. 1A shows show an overhead view of an example of an electrode system consistent with this specification. The electrode system has two active portions that serve as the electrode and counter electrode. The first electrode (110) is an inner electrode and the second electrode (120) surrounds the first electrode (110). Thus, the second electrode (120) serves to shield the first electrode (110). This is because the second electrode (120) completely surrounds the first electrode (110) on a substrate (130). The first and second electrodes (110, 120) may be formed on a substrate (130) using semiconductor fabrication techniques.

The first electrode (110) may be formed from any suitable conductive material. In one example, the electrode is formed from gold due to its inertness and conductivity. Other potentially used materials include platinum, platinum-group metals, silver, copper and/or alloys thereof. Alternately, metals which form resistive surface oxides can be used, for example, tantalum, titanium, aluminum and similar metals. Conductive polymers, fibers, and carbon black loaded organics are also options.

The second electrode (120) may be formed from the same material as the first electrode (110) or a different material. The use of the same material may reduce the number of operations to manufacture the electrodes (110, 120). It may also avoid generating a galvanic potential between the first electrode (110) and the second electrode (120). Similarly, other features of the may be formed in the same layer, for instance, a portion of a firing electrode may be formed simultaneously. Alternately, other sensor components or conductive traces may be formed simultaneously. With microelectrodes, a number of electrodes may be formed in close proximity, resulting in increased potential for interference. The presence of the surrounding second electrode (120) reduces the noise and crosstalk from other sources, including other electrodes. The second electrode (120) can be connected to a ground plane.

The area between the first (110) and second electrodes (120) includes a non-conductive portion of the substrate (130). This material does not have to be strongly insulating, just sufficiently resistive so as not to affect the measurement of the impedance through the fluid. If the fluid is moderately conductive, e.g., includes water and an ionic species, then as long as the substrate layer (130) is not a conductor, accurate measurements of the fluid properties can be obtained although some calibration may be performed in order to baseline the measurements. A wide variety of suitable materials are used in semiconductor fabrication. Further, it may be helpful to use a material that is being deposited or formed as part of another manufacturing operation to avoid adding additional processing operations. Some example materials include silicon, doped silicon, silicon-oxide, silicon-nitride, epoxies (such as SU-8), polymers (such as polyimide), and various other metal oxides, nitrides, carbides, and mixtures thereof.

In FIG. 1B, the substrate (130) is shown recessed compared with the electrodes. However, other geometries are also functional. The electrodes (110,120) may protrude or be flush with the substrate (130) and/or insulating band. However, regardless of the combinations of protrusions formed, the uniformity of the minimum path between the first and second electrodes (110, 120) helps to produce a strong signal to noise ratio. Thus, depending on the combination of materials used for the insulating band, substrate (130), and the electrodes (110, 120) as well as the order of manufacturing operations, some optimization of an etch time may maximize the S/N ratio.

In one example, the surface area of the first (110) and second electrodes (120) are the same. In one example, the outer electrode (120) is connected to ground. The second, outer electrode (120) serves to shield the first, inner electrode (110) and reduce the impact of other electrical operations near the electrode system (100).

The first electrode (110) is surrounded by the second electrode (120). The first (110) and second electrodes (120) are separated on a substrate (130). The substrate (130) acts as an insulating layer between the first electrode (110) and the second electrode (120). If the first electrode (110) and second electrode (120) were in direct electrical contact then the short would prevent measurement of a fluid in contact with the first and second electrodes (110, 120). In one example, the first electrode (110) is centered relative to an opening in the second electrode (120). The first electrode (110) may have a circular cross section and/or exposed area. The second electrode (120) may have a circular opening. The second electrode (120) may be a ring. The first and second electrodes (110, 120) may have equivalent surface areas. The surface area of an electrode is the area of the electrode exposed (or that will be exposed) to the solution being tested.

FIG. 1B shows a profile view of the electrode of FIG. 1A as cut along the dashed line (140). In FIG. 1B, a conductive trace (150) connects the first electrode (110). The trace (150) passes through the substrate (130) which insulates the trace (150) from contact with the solution. By passing through the substrate (130), the trace (150) supplying the first electrode does not disrupt the fluid around the electrode or produce asymmetry in the outer electrode (120) where it passes through. Similarly, the insulating substrate (130) is visible. In some examples, the second electrode (120) is also connected through the substrate (130). Alternately, the second electrode (120) may be electrically connected along the surface of the substrate (130). The second electrode (120) can be connected to ground.

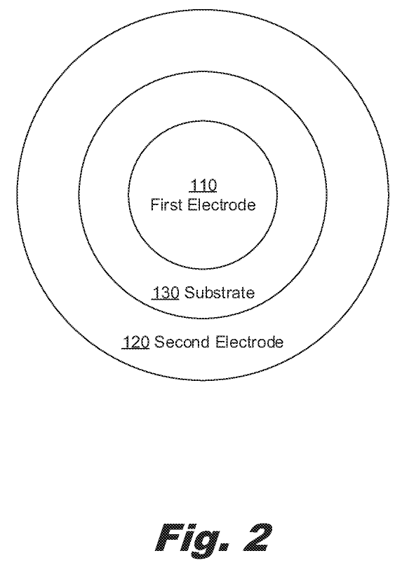

FIG. 2 shows an example of an electrode system consistent with this specification. Here, the first electrode (110) has a circular perimeter. The second electrode (120) has a circular opening. The first electrode (110) is centered in the opening of the second electrode (120). The outer perimeter of the second electrode (120) is similarly a circle such that the second electrode (120) forms a ring of uniform width. In one example, the exposed area of the inner electrode (110) and the outer electrode (120) are equivalent. In one example, the larger exposed area is within 20% of the smaller exposed area. In other examples, the area of the second electrode (120) is significantly larger than the area of the first electrode (110), for example, 150% to 250% of the area of the first electrode (110). The first, inner electrode (110) may include a cutout. For example, the first electrode (110) may also be a ring with a uniform width and an opening in the center. Increasing the outer perimeter of the inner electrode (110) may increase the S/N ratio of the system.

The first electrode (110) may have an outer radius of approximately 47 micrometers and the second electrode (120) may have an inner radius of approximately 54 micrometers and an outer radius of approximately 72 micrometers. The outer electrode (120) may have an outer diameter between approximately 20 micrometers and 300 micrometers. The outer electrode (120) may have an outer diameter between approximately 40 and 150 micrometers. The outer electrode (120) may have an outer diameter between approximately 40 and 200 micrometers. As used within this specification, the term approximately when applied to a dimension indicates to within +/−10% of the listed value of the dimension.

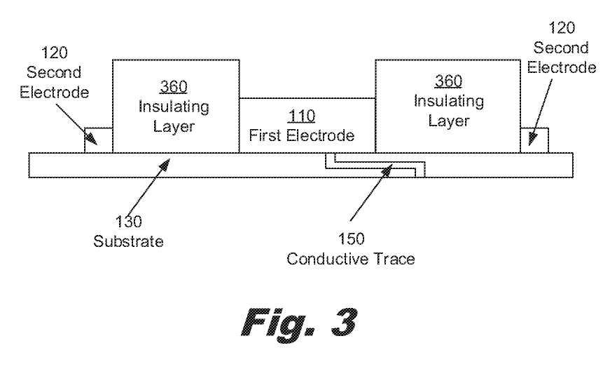

FIG. 3 shows a cross-sectional view of an electrode system consistent with this specification. The first electrode (110) and second electrodes (120) are shown on a substrate (130). A conductive trace (150) connects the first electrode (110) through the substrate (130). Between the first and second electrodes (110, 120) on the substrate (130) is an insulating layer (360). The insulating layer (360) as shown is thicker than the first and second electrodes (110, 120). However, the insulating layer (360) may be of any suitable thickness. The insulating layer (360) may be the same height as the first and second electrodes (110, 120) to produces a uniform fluid flow path over the electrode system. The insulating layer (360) may be lower than the electrodes to produce a design similar to FIG. 1 but with an insulating layer to shield the substrate, for example from contact with the fluid. The insulating layer (360) may be thicker than the first and/or second electrode (110, 120) in order to increase the measured path length. In such cases, control of the thickness uniformity of the insulating layer (360) is helpful to maintain a uniform minimum path length between the first electrode (110) and the second electrode (120). Greater uniformity in the minimum path length may produce higher signal to noise ratios for the electrode system by reducing the variation in the paths traveled between the first and second electrodes (110, 120).

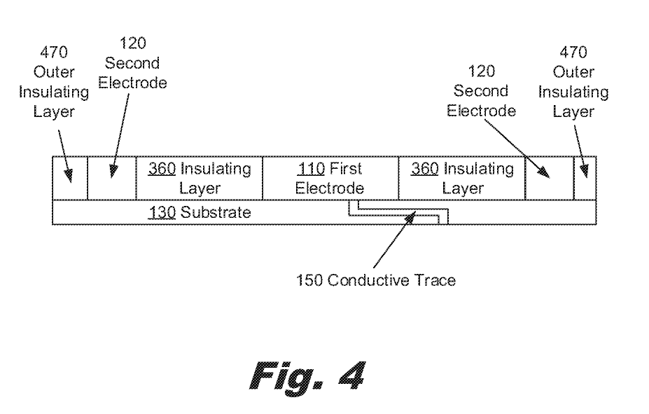

FIG. 4 shows a cross-sectional view of an electrode system consistent with this specification. In this version, the first electrode (110) and second electrode (120) are flush with an insulating layer (360) and outer insulating layer (470). The insulating layer (360), outer insulating layer (470), first electrode (110) and second electrode (120) all present a smooth and/or flush surface to a fluid to test. The insulating layer (360), outer insulating layer (470), first electrode (110) and second electrode (120) are built up on the substrate (130). While the substrate is shown as flat, other variations are also functional. Some of the insulating layer and/or electrodes may have different thicknesses or begin at different depths. This may be helpful for optimizing manufacturing flow and/or reducing the number of manufacturing operations.

An electrode system with a flush surface, as shown in FIG. 4 may have advantages for fluid flow across the electrode system. An electrode system with a flush surface may be formed using etching and/or cutting to produce a reproducible exposed surface area of the first and/or second electrode (110, 120). Not to be bound by any particular theory, but this may be because the exposed surface area is independent of the depth of the cut due to the vertical uniformity of the first and second electrodes (110, 120). This property may make the electrode design robust to processing, improves the reproducibility of the electrode system, and may increase the signal to noise ratio (S/N ratio) for the system.

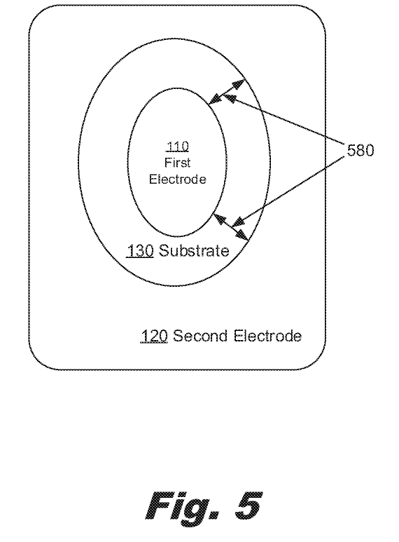

FIG. 5 shows an overhead view of an electrode system consistent with this specification. The system comprises a first electrode (110) and a second electrode (120) on a surface. The surface may be the substrate (130). The first electrode (110) has a smooth outer perimeter, which reduces the current concentrations on any point of the first electrode (110). The second electrode (120) completely surrounds the first electrode (110). There is a minimum separation (580) between the first electrode (110) and the second electrode (120) on the surface that is uniform at all points of a circumference of the first electrode (110). Thus, charge traveling between the two electrodes (110, 120) travels the same minimum distance. This reduces and/or eliminates the impact of protrusions and similar features, which increase the variation of the measurement.

In one example, the first electrode (110) is an oval. The first electrode (110) may be oblong. The first electrode (110) may be a circle centered in an opening and/or cutout of the second electrode (120), the cutout also being a circle. This configuration provides uniform minimum distance but also makes the volumes of fluid associated with each point on the perimeter of the first electrode (120) symmetrical. Accordingly, this symmetry further improves the signal to noise ratio by reducing variation.

The outer perimeter of the second electrode (120) may be smooth. In some example, the use of a smooth outer perimeter of the second electrode (120) enhances the field uniformity between the first electrode (110) and the second electrode (120). A smooth outer perimeter of the second electrode (120) may facilitate uniform fluid behavior and/or flow over the electrode system (100). The use of a smooth outer perimeter of the second electrode (120) may help avoid dead zones

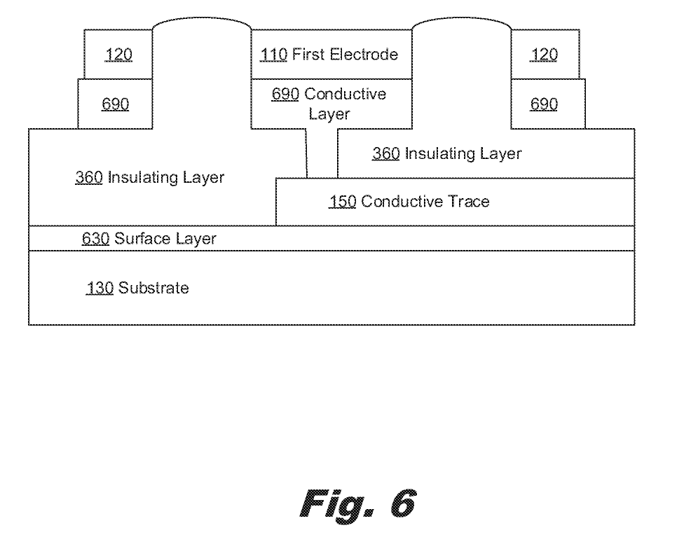

FIG. 6 shows a cross-sectional view of an electrode system consistent with this specification. In this version, the center electrode (110) and second electrode (120) contact separate portions of a conductive layer (690). The electrodes (110, 120) and other elements are supported by a substrate (130). A conductive trace (150) that connects to the first electrode (110) through the conductive layer (690). This example also includes a surface layer (630) on the substrate (130). The surface layer (630) may provide chemical protection or insulate the substrate (130) from the fluid being evaluated. The insulating layer (360) separates the first electrode (110) and second electrode (120) as well as the portions of the conductive layer (690) associated with the first electrode (110) and the second electrode (120).

In one example, the first electrode (110) and second electrode (120) comprises gold. The conductive layer (690) may be formed of, or may comprise, tantalum. The conductive trace (150) may be formed of aluminum. The substrate (130) may be silicon, including doped silicon. The surface layer (630) may be silicon oxide (SiO2). The insulating layer (360) may be formed of silicon carbide. Any of these materials may be substituted with the alternatives described previously.

The insulating layer (360) may include a rounded top between the first electrode (110) and the second electrode (120). The conductive layer (690) may be exposed to a solution being tested. The tested solution is the solution being evaluated by the electrode. In one example, the tested solution is a control solution, such as, phosphate buffered 0.9 wt. % saline (PBS). In one example, the tested solution is an environmental sample, for example, a water sample. In one example, the tested solution is a biological sample, for example, blood or plasma. In one example, The exposed surface of the conductive layer (690) can be oxidized to minimize current transfer through the exposed portions of the conductive layer (690).

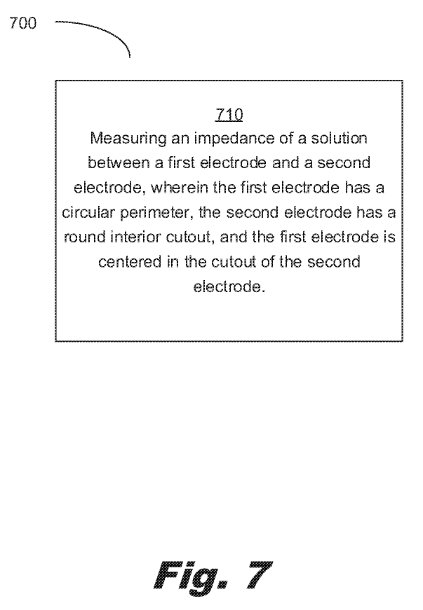

FIG. 7 shows a method (700) consistent with this specification. The method (700) comprises the operation of measuring an impedance of a solution between a first electrode (110) and a second electrode (120), wherein the first electrode (110) has a circular perimeter, the second electrode (120) has a round interior cutout, and the first electrode (110) is centered in the cutout of the second electrode (120) (710).

By placing the first electrode (110) in the cutout of the second electrode (120), the second electrode serves to shield the first electrode (110). Further, the circular perimeter of the first electrode (110) combined with the circular cutout of the second electrode (120) provides a highly symmetrical relationship between the first and second electrodes (110, 120) which increases the signal to noise ratio compared with other electrode geometries.

It will be understood that, within the principles described by this specification, a vast number of variations exist. It should also be understood that the examples described are just examples, and are not intended to limit the scope, applicability, or construction of the claims.

What is claimed is:

1. An electrode system, the system comprising:
a substrate defining a plane;
a first, inner electrode, on the substrate;
a second, outer electrode with a cutout, on the substrate, wherein the first electrode is inside the cutout of the second electrode; and
an insulating layer separating the first electrode and the second electrode.

2. The system of claim 1, wherein the first electrode has a circular perimeter.

3. The system of claim 2, wherein the cutout of the second electrode is circular and the first electrode is concentric with respect to the cutout of the second electrode.

4. The system of claim 1, wherein a surface area of the first electrode and a surface area of the second electrode in the plane are equivalent.

5. The system of claim 1, the first electrode being electrically connected to a trace extending through the substrate.

6. The system of claim 1, wherein an outer diameter of the second electrode is between 40 and 150 micrometers.

7. The system of claim 1, wherein the first electrode and the second electrode are both comprise a common material.

8. The system of claim 1, wherein the second electrode is connected to ground.

9. The system of claim 1, wherein the electrode system is part of a microfluidic device.

10. A method of making an impedance measurement, the method comprising:
measuring an impedance of a solution between a first electrode and a second electrode, wherein the first electrode has a circular perimeter, the second electrode has a round interior cutout, and the first electrode is centered in the cutout of the second electrode.

11. The method of claim 10, wherein the first electrode and the second electrode have equivalent surface areas.

12. The method of claim 10, wherein the second electrode is an unbroken ring.

13. A system for making electrical measurements, the system comprising:
a first electrode and second electrode on a surface, wherein the first electrode has a smooth outer perimeter;
the second electrode completely surrounds the first electrode on the surface; and
a minimum separation between the first electrode and the second electrode on the surface is uniform at all points of a circumference of the first electrode.

14. The system of claim 14, wherein the second electrode has a maximum dimension of 40 to 200 micrometers.

15. The system of claim 15, wherein an outer perimeter of the second electrode is smooth.
